(19) United States
(12) Patent Application Publication
(10) Pub. No.: US 2011/0013762 A1
(43) Pub. Date: Jan. 20, 2011

(54) NOTIFICATION APPARATUS & METHOD

(76) Inventor: Gregg Bieser, Highland Park, IL (US)

Correspondence Address: CARDINAL LAW GROUP, Suite 2000, 1603 Orrington Avenue, Evanston, IL, 60201, US

(21) Appl. No.: 12/838,283

(22) Filed: Jul. 16, 2010

Related U.S. Application Data
(60) Provisional application No. 61/284,692, filed on Dec. 22, 2009.
(60) Provisional application No. 61/271,134, filed on Jul. 18, 2009.

(51) Int. Cl. H04M 1/56; G06F 13/12; G06F 12/00

(52) U.S. Cl. 379/142.13; 710/63; 711/115; 711/E12.001

(57) ABSTRACT

An apparatus for issuing notifications includes at least a first input configured to recognize an incoming call, at least a first notification interface, and at least a first controller. The first controller is in electrical communication with the first input and the first notification interface. The apparatus further includes a first memory in electrical communication with the first controller. The memory is configured to store at least one destination. The first controller is configured to issue at least one notification message responsive to a recognized incoming call, wherein the notification message is issued to at least one destination via the notification interface.

### RELATED APPLICATIONS

This application claims the benefit of, and priority to U.S. Provisional Patent Application 61/284,692 filed Dec. 22, 2009 and also the benefit of and priority to U.S. Provisional Patent Application 61/271,134 filed on Jul. 18, 2009. The entirety of each application is incorporated by reference herein.

### TECHNICAL FIELD

This invention relates generally to notification devices. The invention more particularly relates to notification devices that issue notifications based on a predetermined condition.

### BACKGROUND OF THE INVENTION

As the speed of communication increases in an increasingly connected age, it can be just as important to know the identity of a caller, or the mere existence of a call, and be promptly notified of this information, than to actually receive the call. Additionally, as abusive treatment of phones increases, especially as directed at the elderly, it can be quite desirable for caretakers to know who is calling people, and when, regardless of the location of the caretaker.

Call ‘screening’ is a known strategy for obtaining the benefit of knowledge of the identity of the caller, but without actually ‘taking’ the call. However, call screening is only a viable strategy if the call screener is in the proximity of the ringing telephone, and screening is not viable for remote locations, or notifying numerous people of a call.

Although call forwarding services are well known in the art, such services actually transfer the call, rather than simply notifying the intended recipient of the call. Actual receipt of the call may be less desirable than simple knowledge of its existence. Call forwarding can also require inconvenient and frequent reprogramming of phone lines.

Furthermore, it may be desirable to receive notifications of other conditions at a remote location, in particular for caretakers. For example, it can be desirable to receive information that a senior citizen parent fell, or left a particular area, or simply needs assistance. Use of telephones and other devices can resolve these problems under certain circumstances, but use of the telephone requires active participation from the person being monitored since that person needs to not only pick up the phone, but also want to pick up the phone. Other devices, such as the LifeAlert® device, operate using a button press, but do not provide for a high level of customization or for a robust communication method. Furthermore, other devices may connect to a centralized, staffed, location such as a call center, but do not directly communicate with a concerned party. Use of a call center can be desirable, but introduces latency to the communication as well as potential inefficiencies, not to mention cost. This may not be possible if the phone is not within reach, or if the person is suffering from dementia, or simply forgets. These deficits of phone usage are amplified, if, for example, a facility desires to monitor numerous persons for their location, well being, and protection.

Therefore, it would be desirable to provide an apparatus and method that overcomes the aforementioned and other disadvantages.

### SUMMARY OF THE INVENTION

A first embodiment of the invention provides an apparatus for issuing notifications. The apparatus includes at least a first input configured to recognize an incoming call, at least a first notification interface, and at least a first controller. The first controller is in electrical communication with the first input and in further electrical communication with the first notification interface. The apparatus further includes a first memory in electrical communication with the first controller. The memory is configured to store at least one destination and the first controller is configured to issue at least one notification message responsive to a recognized incoming call. The notification message is issued to at least one destination via the notification interface.

Another embodiment of the invention provides an apparatus for issuing notifications. The apparatus includes at least a first input configured to recognize an incoming call and at least a first event trigger configured to actuate a signal responsive to a predetermined condition. The apparatus further includes at least a first notification interface configured to issue at least one notification message, at least a first controller in electrical communication with the first event trigger and in further electrical communication with the first notification interface. The first controller receives the actuated signal. The apparatus further includes a first memory in electrical communication with the first controller. The memory is configured to store at least one destination. The first controller is configured to issue at least one notification message to at least one destination responsive to receiving an actuated signal, wherein the notification message is issued via the notification interface.

Yet another embodiment of the invention provides a system for issuing notifications. The system includes at least a first input configured to recognize an incoming call, at least a first event trigger configured to actuate a signal responsive to a predetermined condition, and at least a first notification interface configured to issue at least one notification message. The system further includes at least a first controller, the first controller in electrical communication with the first event trigger. The first controller is in further electrical communication with the first notification interface, and the first controller receives the actuated signal. The system further includes a first memory in electrical communication with the first controller, and the memory is configured to store at least one destination. The first controller is configured to issue at least one notification message to at least one destination responsive to receiving an actuated signal. The notification message is issued via the notification interface. The system additionally includes at least a first remote transceiver configured to wirelessly communicate with the event trigger. Furthermore, the remote transceiver is in electrical communication with at least a first sensor.

Yet another embodiment of the invention provides a system for issuing notifications. The system includes at least a first input configured to recognize an incoming call, at least a first event trigger configured to actuate a signal responsive to a predetermined condition, and at least a first notification interface configured to issue at least one notification message. The system further includes at least a first controller in electrical communication with the first event trigger and in further electrical communication with the first notification interface, wherein the first controller receives the actuated signal. The system further includes a first memory in electrical communication with the first controller, and wherein the memory is configured to store at least one destination. The first controller is configured to issue at least one notification message to at least one destination responsive to receiving an actuated signal, wherein the notification message is issued via the notification interface. Furthermore, the system includes at least a first remote transceiver in electrical communication with at least a first sensor, the transceiver configured to wirelessly communicate on a predetermined intermittent schedule with the event trigger.

Another embodiment of the invention provides a system for issuing notifications. The system includes at least a first event trigger configured to actuate a signal responsive to a predetermined condition, at least a first controller in electrical communication with the first event trigger and in further electrical communication with a first notification interface, wherein the first controller receives the actuated signal, and at least a first memory in electrical communication with the first controller. The first memory is configured to store at least one destination list, each destination list including at least one destination. The first controller is configured to issue at least one notification message to at least one destination responsive to receiving an actuated signal, wherein the notification message is issued via the notification interface. The system further includes at least one remote transceiver configured to wirelessly communicate on a predetermined intermittent schedule with the event trigger. The remote transceiver is in electrical communication with at least a first sensor, and each of the remote transceivers includes a unique identifier, and wherein each unique identifier is associated with at least one destination list. The transceiver transmits the unique identifier to the event trigger, and the notification message is issued responsive to the unique identifier.

Another aspect of the invention provides a method of issuing a notification. The method includes recognizing a call at an apparatus including at least a first input configured to recognize an incoming call, at least a first notification interface, at least a first controller, the first controller in electrical communication with the first input, the first controller in further electrical communication with the first notification interface, and a first memory in electrical communication with the first controller, and wherein the memory is configured to store at least one destination. The method further includes identifying, at the controller, at least a first characteristic responsive to the recognizing the call, matching the characteristic to at least a first destination selected from the at least one destination, and issuing a notification message to the first destination based on the matching.

Another aspect of the invention provides a method of issuing a notification. The method includes receiving an actuated signal at an apparatus that includes at least a first input configured to recognize an incoming call, at least a first event trigger configured to actuate a signal responsive to a predetermined condition, at least a first notification interface configured to issue at least one notification message, at least a first controller, the first controller in electrical communication with the first event trigger, the first controller in further electrical communication with the first notification interface, and wherein the first controller receives the actuated signal, and a first memory, the first memory in electrical communication with the first controller, and wherein the memory is configured to store at least one destination. The method further includes identifying, at the controller, at least a first characteristic responsive to the receiving the actuated signal, matching the characteristic to at least a first destination selected from the at least one destination, and issuing a notification message to the first destination based on the matching.

The aforementioned and other features and advantages of the invention will become further apparent from the following detailed description of the presently preferred embodiments, read in conjunction with the accompanying drawings, which are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 shows a schematic view of one embodiment of an apparatus in accordance with the present invention;

FIG. 2 shows a schematic view of another embodiment of an apparatus in accordance with the present invention;

FIG. 3 shows a schematic view of another embodiment of an apparatus in accordance with the present invention;

FIG. 4 shows a schematic view of another embodiment of an apparatus in accordance with the present invention;

FIG. 5 shows a schematic view of another embodiment of an apparatus in accordance with the present invention;

FIG. 6 shows a schematic view of another embodiment of an apparatus in accordance with the present invention;

FIG. 7 shows a view of the destination lists in accordance with one aspect of the invention;

FIG. 8 and FIG. 9 illustrate methods in accord with other aspects of the invention.

### DETAILED DESCRIPTION OF THE PRESENTLY PREFERRED EMBODIMENTS

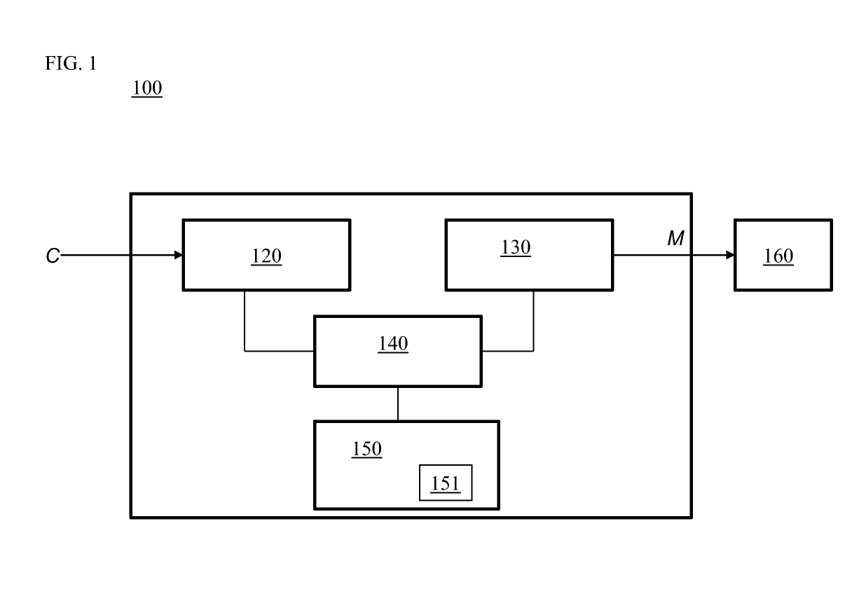

FIG. 1 illustrates a schematic view of an apparatus 100 for issuing notifications. Apparatus 100 includes at least a first input 120 configured to recognize an incoming call C, at least a first notification interface 130, and at least a first controller 140. The first controller 140 is in electrical communication with the first input 120 and the first notification interface 130. The apparatus 100 further includes a first memory 150 in electrical communication with the first controller 140. The first memory 150 is configured to store at least one destination 151. The first controller 140 is configured to issue at least one notification message M responsive to a recognized incoming call, wherein the notification message M is issued to at least one destination 160 via the notification interface 130. Destination 160 is associated with destination 151 in that destination 151 provides the description and criteria for issuing the notification message to destination 160. For example, if destination 160 is a phone number, the phone number is stored at destination 151, whereas if destination 160 is an email address, the email address is stored at destination 151.

When a phone call is received at the apparatus, the apparatus determines the caller ID information (such as the number making the call, identity of the caller, etc.) associated with the call, and then issues a notification message to a destination based on the caller ID information. In one embodiment, the notification message includes the caller ID information, whereas, in other embodiments, the caller ID information is not included. Thus, the notification message can serve as either notification of exactly who is calling, or may serve as a bare notification that a call was received. Thus, a third party can receive notice of the call, possibly even including the identity of the caller, in order to help expedite customer service and return calls, as well as potentially assist in monitoring infirm patients or relatives who might be subject to harassing phone calls or the like.

Incoming call C can be received from any appropriate network, including a POTS (Plain Old Telephone Service), or circuit switched network, as well as a packet switched network, such as a network operating on a protocol such as the Internet, or other such protocol driven data transmission network. Likewise, the notification message M can be issued to any appropriate network, including a POTS, circuit switched network, or a packet switched network. Thus, first input 120, in one embodiment, includes an interface configured to interact with a POTS network and includes a phone jack.

In one embodiment, the controller can be configured to issue different notification messages, or issue notification messages to different destinations, based on circumstances. In one such embodiment, the controller only issues a notification message if the phone rings more than a predetermined number of rings, such as 3. In other embodiments, the controller can be configured to ignore certain numbers, and not issue notifications based on the certain number. In another embodiment, the controller can issue notifications only if a particular number calls in excess of a predetermined threshold within a predetermined time span, such as twice a day.

The controller 140 is any appropriate programmable controller configured to receive instructions, process the instructions and issue instructions responsive to the processing. The controller 140 may be an ASIC, or a general purpose controller specifically programmed for the tasks to be performed. In one embodiment, the controller 140 is implemented as a GHI Electronics Embedded Master Module. The memory 150 may be RAM or ROM, and may be a fixed device, such as a hard drive, or can be a removable media, including a USB device or other such removable media, including floppy discs or other formatted portable medium.

Thus, destination 151 can be any appropriate destination, such as an email account, phone number, facebook account, pager number, twitter account, fax number, or the like. Additionally, each destination can be configured to include multiple destinations, so that a notification to an individual goes to multiple separate addresses. Thus, a destination of “dad” can be configured to simply send the notification message to a phone number, or the same destination can be configured to send the notification message to a phone number or numbers, plus send an email or emails to at least one email address. These configurations can further be established to be dependent on the source of the call C. Destination 151 includes a predetermined list and rules for issuing notifications to the predetermined list. Destination 151 identifies the location and criteria for issuing the notification.

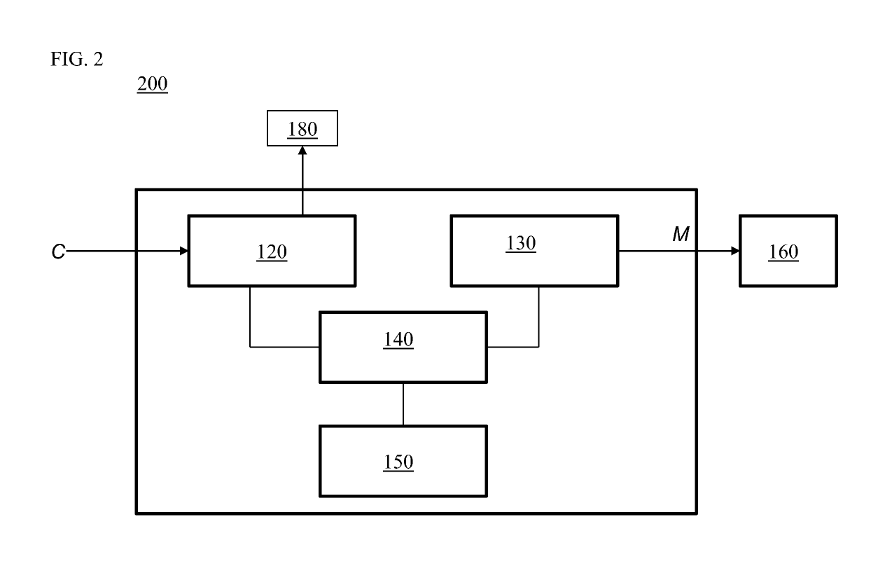

In one embodiment, apparatus 100 further includes at least a first output. Specifically, in one embodiment, apparatus 100 includes a first output configured to communicate with at least a first telephone 180, as illustrated in FIG. 2. In this embodiment, the apparatus 200 can be placed in series between a wall jack for a telephone, and the telephone itself to receive the call, issue the notification message to the desired destination, and deliver the received phone call to the telephone to connect the call. Such embodiments can reduce the complexity of installation.

The notification message can take a number of forms, including, but not limited to email, text message, SMS message, telephone call, pager message, instant message, tweet, or the like. In various embodiments, the notification message will include the recipient phone number, the caller ID information associated with the incoming call, the date, time, or other such information. The format of the message can be configured individually, or in a group, and the complexity of the message can likewise be configured. For example, if the caller ID information is not recognized by apparatus 100, in certain embodiments a more robust or more complete message can be transmitted, whereas in other embodiments, where the caller ID information is likewise not recognized by apparatus 100, a reduced detail notification message can be sent. The complexity and level of detail in the notification message can be set by users as desired, in certain embodiments.

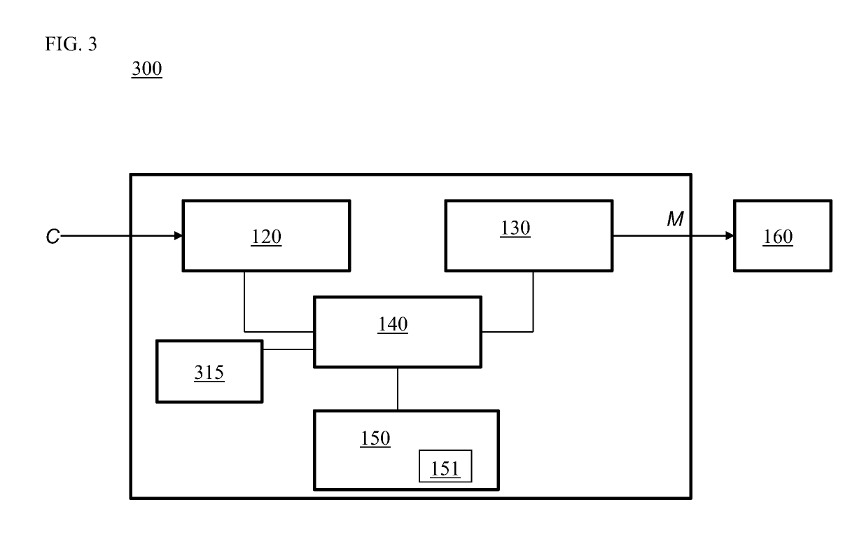

FIG. 3 illustrates another aspect of the invention as apparatus 300. Apparatus 300 includes at least a first input 120 configured to recognize an incoming call C and at least a first event trigger 315 configured to actuate a signal responsive to a predetermined condition. Additionally, apparatus 300 includes at least a first notification interface 130, and at least a first controller 140. The first controller 140 is in electrical communication with the first input 120 and the first notification interface 130. First event trigger 315 is in electrical communication with first controller 140. The apparatus 300 further includes a first memory 150 in electrical communication with the first controller 140. The first memory 150 is configured to store at least one destination 151. The first controller 140 is configured to issue at least one notification message M responsive to a recognized incoming call, wherein the notification message M is issued to at least one destination 160 via the notification interface 130. In one embodiment, the commonly numbered structures with FIG. 1 are implemented as in accord with the description of FIG. 1.

As noted above, the event trigger 315 actuates a signal responsive to a predetermined condition. The signal can be a portion of a notification message, or the notification message itself. The predetermined condition is, in one embodiment, the receipt of a transmission from a remote device. The remote device can include any number of signal actuation devices, including sensors (such as temperature, speed, height, and accelerometers), buttons, or the like. In one embodiment, the remote device is implemented as the remote transceiver discussed in further detail below.

Thus, in embodiments that feature the event trigger 315, the apparatus 300 can issue a notification message responsive to the predetermined condition, such that the notification message can be issued responsive to occurrences other than receipt of a phone call as was described with respect to FIG. 1. Additionally, the apparatus can be further configured to issue notification messages or not issue notification messages under predetermined circumstances. Different rules can apply at different times of day or days of weeks.

The notification message issued in response to the predetermined condition can include any number of pieces of information. The notification message may simply include a notice of a generic condition (such as a simple red light or other such binary signal) or the notification message may include a robust data stream including time, place, type of predetermined condition, or the like. The level of detail contained in the notification message may be as low or as complex as desired, and may be even be configurable based on a rule set.

In one embodiment, apparatus 300 further includes at least a first output. Specifically, in one embodiment, apparatus 300 includes a first output configured to communicate with at least a first telephone 180, similar to apparatus 200 as illustrated in FIG. 2. In this embodiment, the apparatus 300 can be placed in series between a wall jack for a telephone, and the telephone itself to receive the call, issue the notification message to the desired destination, and deliver the received phone call to the telephone to connect the call. Such embodiments can reduce the complexity of installation.

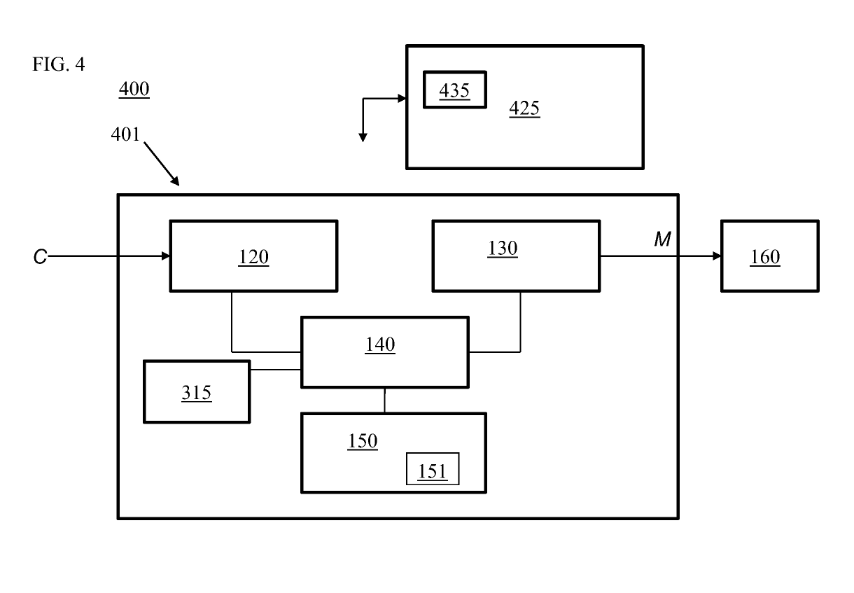

FIG. 4 illustrates another aspect of the invention as system 400. System 400 includes apparatus 401 which includes at least a first input 120 configured to recognize an incoming call C and at least a first event trigger 315 configured to actuate a signal responsive to a predetermined condition. Additionally, apparatus 401 includes at least a first notification interface 130, and at least a first controller 140. The first controller 140 is in electrical communication with the first input 120 and the first notification interface 130. First controller 140 is further in electrical communication with first event trigger 315. The apparatus 401 further includes a first memory 150 in electrical communication with the first controller 140. The first memory 150 is configured to store at least one destination 151. The first controller 140 is configured to issue at least one notification message M responsive to a recognized incoming call, wherein the notification message M is issued to at least one destination 160 via the notification interface 130. In one embodiment, the commonly numbered structures with FIG. 4 are implemented as in accord with the description of FIG. 1.

As noted above, the event trigger 315 actuates a signal responsive to a predetermined condition. The signal can be a portion of a notification message, or the notification message itself. The predetermined condition is, in one embodiment, the receipt of a transmission from a remote device. The remote device can include any number of signal actuation devices, including sensors (such as temperature, speed, height, and accelerometers), buttons, or the like. In one embodiment, the remote device is implemented as remote transceiver 425.

Remote transceiver 425 is a transceiver configured to communicate with apparatus 401. The communication can be a wired communication. In one embodiment of the invention, remote transceiver 425 communicates with the apparatus 401 using a wireless system, operating with a wireless communication protocol. The wireless communication protocol can be any protocol, including a FCC Part 13 protocol, such as an 802.11 protocol, or a zigbee protocol. Other protocols are envisioned, such as a radio transmission, an infrared transmission or the like. The remote transceiver 425 is in electrical communication with a first sensor 435. In one embodiment, the remote transceiver 425 and first sensor 435 are housed within a housing.

First sensor 435 can be any appropriate sensor configured to sense a condition. The condition can be a button press, temperature, acceleration, velocity, time, distance, position, position change, GPS or the like. Thus, in one embodiment first sensor 435 includes an accelerometer. In one embodiment first sensor 435 includes an accelerometer, and the remote transceiver issues a signal responsive to conditions sensed by the accelerometer. In one embodiment first sensor 435 includes a gyroscope, and the remote transceiver issues a signal responsive to conditions sensed by the gyroscope. In one embodiment first sensor 435 includes a speedometer, and the remote transceiver issues a signal responsive to conditions sensed by the speedometer. In one embodiment, first sensor 435 includes a GPS device, and the remote transceiver issues a signal responsive to conditions sensed by the GPS device. In one embodiment first sensor 435 includes a push button, and the remote transceiver issues a signal responsive to conditions sensed by the push button. In one embodiment, first sensor 435 includes a temperature sensor, and the transceiver issues a signal responsive to conditions sensed by the temperature sensor.

Thus, in embodiments that feature the event trigger 315, the apparatus 400 can issue a notification message responsive to the predetermined condition, such that the notification message can be issued responsive to occurrences other than receipt of a phone call as was described with respect to FIG. 1.

The notification message issued in response to the predetermined condition can include any number of pieces of information. The notification message may simply include a notice of a generic condition (such as a simple red light or other such binary signal) or the notification message may include a robust data stream including time, place, type of predetermined condition, or the like. The level of detail contained in the notification message may be as low or as complex as desired, and may be configurable based on a rule set.

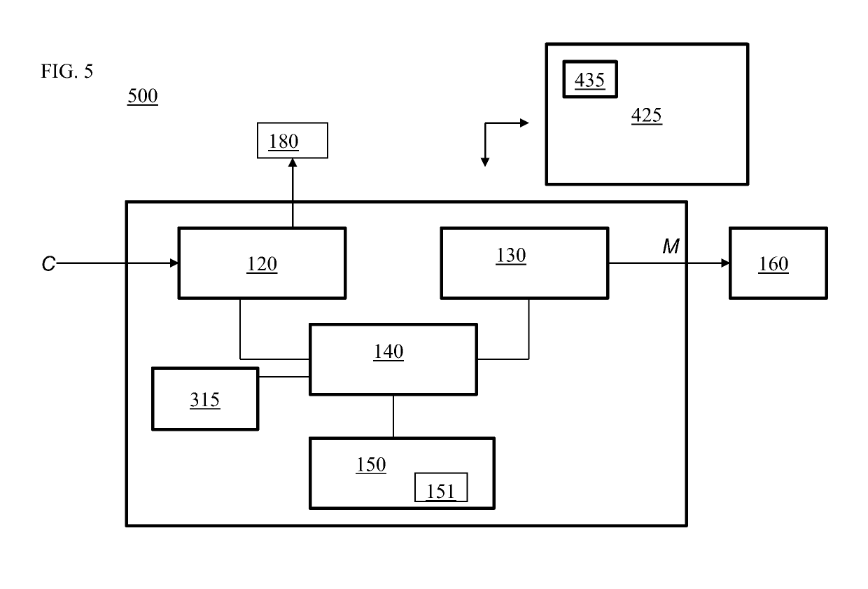

In one embodiment, apparatus 401 further includes at least a first output. Specifically, in one embodiment, apparatus 401 includes a first output configured to communicate with at least a first telephone 180, similar to apparatus 200 as illustrated in FIG. 2. In this embodiment, the apparatus 401 can be placed in series between a wall jack for a telephone, and the telephone itself to receive the call, issue the notification message to the desired destination, and deliver the received phone call to the telephone to connect the call. Such embodiments can reduce the complexity of installation. In other embodiments, system 400 further includes at least a first output to communicate with at least a first telephone 180, as illustrated in FIG. 5 as system 500.

In yet other embodiments, the remote transceiver 425 is configured to wirelessly communicate on a predetermined intermittent schedule with the event trigger 315. In response to the communication, the controller can either issue a notification message responsive either to receipt of the communication, or alternatively responsive to a failure to receive a communication according to the predetermined intermittent schedule. The event trigger 315 may fail to receive the communication for several reasons, including that the remote transceiver is no longer within transmission range, the battery or other power source has insufficient power to transmit the communication or other reasons. Thus, the notification message can issue responsive to either receipt of a ‘ping’ from the remote transceiver, or failure to receive the ‘ping’. The predetermined intermittent schedule, in one embodiment, is configurable. For example, a relatively long predetermined intermittent schedule, such as a communication every 30 minutes, may be desirable for low importance warnings, while shorter time spans, such as 60 seconds may be appropriate in other situations. In certain embodiments, a reverse ping is conducted in an attempt to reduce false positives, such that the apparatus 401 may attempt to contact the remote transceiver to initiate a ping in the event of a failed communication or other potential situation. The reverse ping may be issued quite quickly or rather slowly, in a configured setup. Any appropriate time span can be used for either the predetermined intermittent schedule or the reverse ping. Longer intermittent schedules may improve battery life due to lower frequency of transmission, but at the cost of potentially outdated information.

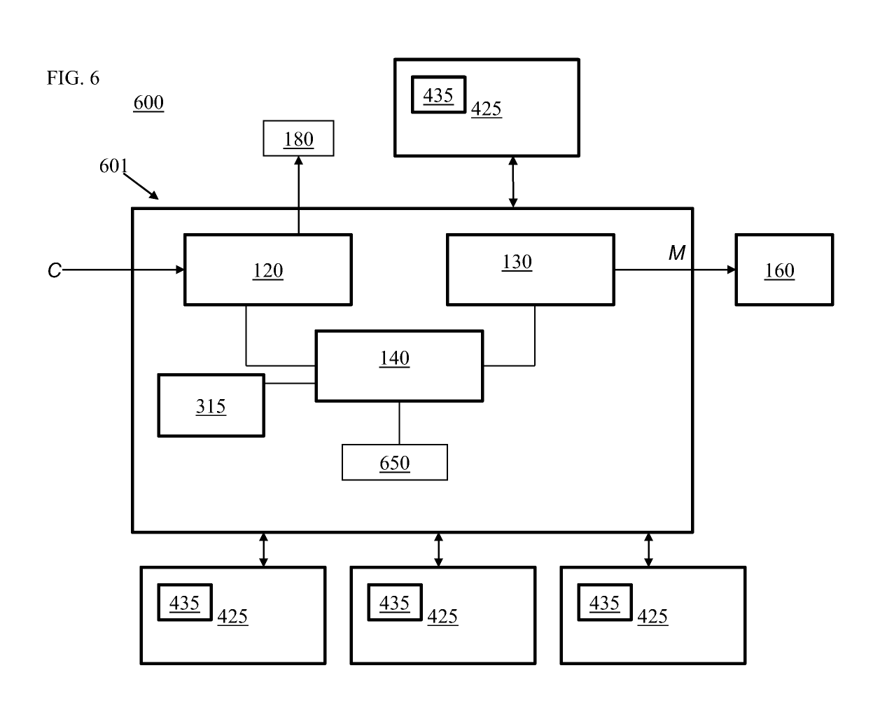

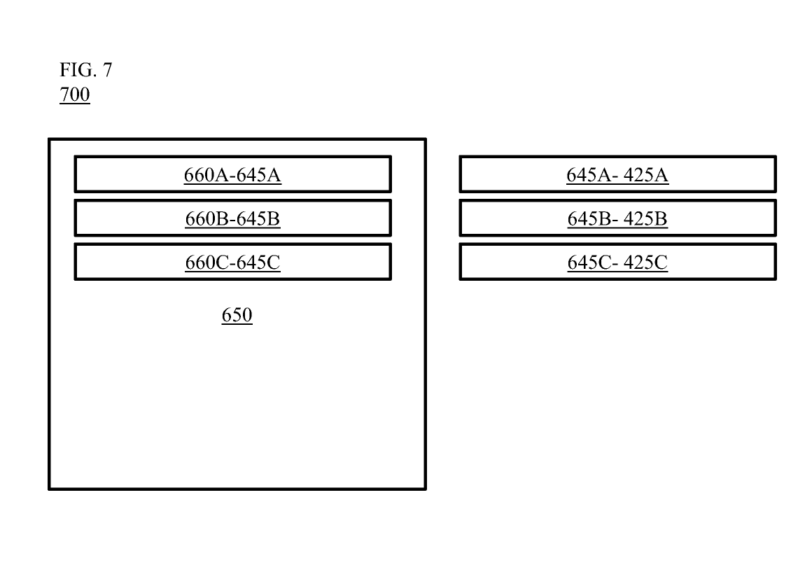

FIG. 6 illustrates yet another embodiment of the invention. In FIG. 6, system 600 includes a plurality of remote transceivers 425, each with an associated sensor 435. In such an embodiment, a single apparatus, such as apparatus 601, can be used to issue notification messages based on communications from any number of remote transceivers. For example, a facility housing a number of people could issue each person a remote transceiver 425, and a centralized apparatus 601 can monitor each remote transceiver and issue notification messages responsive to conditions from the remote transceiver. Thus, the memory 650 includes a list of destinations, each destination associated with a unique identifier associated with each remote transceiver. Thus, FIG. 7 illustrates a schematic showing that memory 650 includes a list of destinations 660A, 660B, and 660C, each respectively associated with a unique identifier 645A, 645B, and 645C. Additionally, FIG. 7 additionally illustrates that unique identifier 645A, 645B, and 645C are each respectively associated with a remote transceiver 425A, 425B, and 425C. In such a fashion, responsive to the predetermined condition, the notification message can be issued to the destination associated with the remote transceiver.

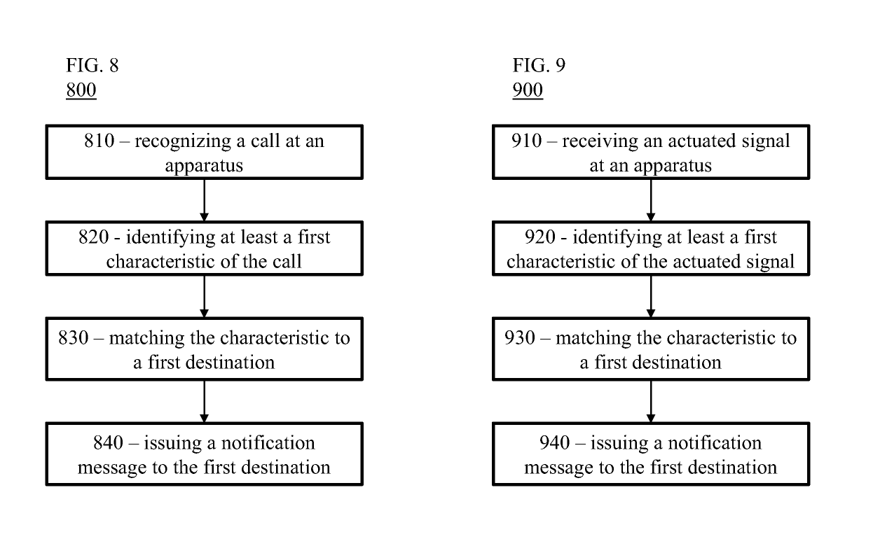

FIG. 8 illustrates one embodiment of a method 800 of issuing a notification in accordance with one aspect of the invention. Method 800 begins at 810 by recognizing a call at an apparatus including at least a first input configured to recognize an incoming call, at least a first notification interface, at least a first controller, the first controller in electrical communication with the first input, the first controller in further electrical communication with the first notification interface, and a first memory in electrical communication with the first controller, and wherein the memory is configured to store at least one destination. In one embodiment, the apparatus of step 810 is implemented as an apparatus of FIG. 1. Method 800 continues at step 820 by identifying, at the controller, at least a first characteristic responsive to the recognizing and at step 830 by matching the characteristic to at least a first destination selected from the at least one destination. Method 800 completes by issuing a notification message to the first destination based on the matching.

FIG. 9 illustrates an alternate method 900 of issuing a notification in accordance with an aspect of the invention. Method 900 begins at 910 by receiving an actuated signal at an apparatus, the apparatus including at least a first input configured to recognize an incoming call, at least a first event trigger configured to actuate a signal responsive to a predetermined condition, at least a first notification interface configured to issue at least one notification message, at least a first controller, the first controller in electrical communication with the first event trigger, the first controller in further electrical communication with the first notification interface, and wherein the first controller receives the actuated signal, and a first memory, the first memory in electrical communication with the first controller, and wherein the memory is configured to store at least one destination. Method 900 continues at step 920 by identifying, at the controller, at least a first characteristic responsive to the receiving, and at step 930 by matching the characteristic to at least a first destination selected from the at least one destination. Method 900 completes at step 940 by issuing a notification message to the first destination based on the matching.

The use of the term “transceiver” is intended to include devices that solely transmit signals, as well as devices that transmit and receive signals.

Those of ordinary skill in the art will readily recognize several advantages of the disclosures herein. The apparatus and methods do not require a personal computer, so set up is simplified. The notification message can be issued in any number of configurable forms. The apparatus itself is format-neutral to enable ease of updating. The system uses existing networks and protocols to accomplish its goals, although certainly custom networks or protocols could be developed to attain the ends.

The configurations described herein can be accomplished using an interface within or connected to the apparatus, or, can be remotely accomplished. In embodiments allowing for a remote configuration, the apparatus may have an individual address or other manner of identification over a network, such as an IP address for devices attached to the Internet. In such embodiments, a user interface, such as a Graphical User Interface receives configuration instructions from a user and configures the apparatus based on the configuration instructions.

While the embodiments of the invention disclosed herein are presently considered to be preferred, various changes and modifications can be made without departing from the spirit and scope of the invention. The scope of the invention is indicated in the appended claims, and all changes and modifications that come within the meaning and range of equivalents are intended to be embraced therein.

What is claimed is:

1. An apparatus for issuing notifications, the apparatus comprising:
at least a first input configured to recognize an incoming call;
at least a first notification interface;
at least a first controller, the first controller in electrical communication with the first input, the first controller in further electrical communication with the first notification interface; and
a first memory, the first memory in electrical communication with the first controller, and wherein the memory is configured to store at least one destination; and wherein the first controller is configured to issue at least one notification message responsive to a recognized incoming call, wherein the notification message is issued to at least one destination via the notification interface.

2. The apparatus of claim 1 wherein the notification interface issues the at least one notification message over at least one of a packet switched network and a circuit switched network.

3. The apparatus of claim 1 further comprising at least a first output configured to communicate with at least a first telephone.

4. The apparatus of claim 1 wherein the first memory comprises a removable medium.

5. The apparatus of claim 4 wherein the removable medium comprises a USB device.

6. The apparatus of claim 1 wherein the notification message comprises an identification of a source of the incoming call.

7. The apparatus of claim 6 wherein the notification message comprises at least one of the group consisting of email, text message, SMS, telephone call, instant message, page, and tweet.

8. An apparatus for issuing notifications, the apparatus comprising:
at least a first input configured to recognize an incoming call;
at least a first event trigger configured to actuate a signal responsive to a predetermined condition;
at least a first notification interface configured to issue at least one notification message;
at least a first controller, the first controller in electrical communication with the first event trigger, the first controller in further electrical communication with the first notification interface, and wherein the first controller receives the actuated signal; and
a first memory, the first memory in electrical communication with the first controller, and wherein the memory is configured to store at least one destination; and wherein the first controller is configured to issue at least one notification message to at least one destination responsive to receiving an actuated signal, wherein the notification message is issued via the notification interface.

9. The apparatus of claim 8 wherein the notification message is issued via at least one of a packet switched network and a circuit switched network.

10. The apparatus of claim 8 wherein the first memory comprises a removable medium.

11. The apparatus of claim 8 further comprising at least a first output configured to communicate with at least a first telephone.

12. The apparatus of claim 8 wherein the notification message comprises an identification of a source of the predetermined condition.

13. The apparatus of claim 12 wherein the source comprises at least one of a push-button, a GPS sensor, a gyroscope, accelerometer, and a temperature sensor.

14. The apparatus of claim 12 wherein the source comprises at least one environmental sensor selected from the group consisting of a carbon monoxide detector, smoke detector, and temperature detector.

15. The apparatus of claim 12 wherein the notification message comprises at least one of the group consisting of email, text message, SMS, telephone call, instant message, and tweet.

16. A system for issuing notifications, the system comprising:
at least a first input configured to recognize an incoming call;
at least a first event trigger configured to actuate a signal responsive to a predetermined condition;
at least a first notification interface configured to issue at least one notification message;
at least a first controller, the first controller in electrical communication with the first event trigger, the first controller in further electrical communication with the first notification interface, and wherein the first controller receives the actuated signal;
a first memory, the first memory in electrical communication with the first controller, and wherein the memory is configured to store at least one destination; and wherein the first controller is configured to issue at least one notification message to at least one destination responsive to receiving an actuated signal, wherein the notification message is issued via the notification interface; and
at least a first remote transceiver configured to wirelessly communicate with the event trigger, the remote transceiver in electrical communication with at least a first sensor.

17. The system of claim 16 wherein the notification message is issued via at least one of a packet switched network and a circuit switched network.

18. The system of claim 16 wherein the first memory comprises a removable medium.

19. The system of claim 16 further comprising at least a first output configured to communicate with at least a first telephone.

20. The system of claim 16 wherein the first sensor comprises an accelerometer, and wherein the transceiver issues a signal responsive to conditions sensed by the accelerometer.

21. The system of claim 16 wherein the first sensor comprises a gyroscope, and wherein the transceiver issues a signal responsive to conditions sensed by the gyroscope.

22. The system of claim 16 wherein the first sensor comprises a push button, and wherein the transceiver issues a signal responsive to conditions sensed by the push button.

23. The system of claim 16 wherein the first sensor comprises a GPS sensor, and wherein the transceiver issues a signal responsive to conditions sensed by the GPS sensor.

24. The system of claim 16 wherein the first sensor comprises a temperature sensor, and wherein the transceiver issues a signal responsive to conditions sensed by the temperature sensor.

25. The system of claim 16 wherein the notification message comprises an identification of the predetermined condition.

26. The system of claim 25 wherein the notification message comprises at least one of the group consisting of email, text message, SMS, telephone call, instant message, and tweet.

27. A system for issuing notifications, the system comprising:
at least a first input configured to recognize an incoming call;
at least a first event trigger configured to actuate a signal responsive to a predetermined condition;
at least a first notification interface configured to issue at least one notification message;
at least a first controller, the first controller in electrical communication with the first event trigger, the first controller in further electrical communication with the first notification interface, and wherein the first controller receives the actuated signal;
a first memory, the first memory in electrical communication with the first controller, and wherein the memory is configured to store at least one destination; and wherein the first controller is configured to issue at least one notification message to at least one destination responsive to receiving an actuated signal, wherein the notification message is issued via the notification interface; and
at least a first remote transceiver configured to wirelessly communicate on a predetermined intermittent schedule with the event trigger, the remote transceiver in electrical communication with at least a first sensor.

28. The system of claim 27 wherein the notification message is issued via at least one of a packet switched network and a circuit switched network.

29. The system of claim 27 wherein the first memory comprises a removable medium.

30. The system of claim 27 further comprising at least a first output configured to communicate with at least a first telephone.

31. The system of claim 27 wherein the first controller issues the notification message responsive to receipt of a communication from the first remote transceiver.

32. The system of claim 27 wherein the first controller issues the notification message responsive to a failure to receive a communication according to the predetermined intermittent schedule.

33. The system of claim 27 wherein the notification message comprises an identification of the predetermined condition.

34. The system of claim 33 wherein the notification message comprises at least one of the group consisting of email, text message, SMS, telephone call, instant message, and tweet.

35. A system for issuing notifications, the system including;
at least a first event trigger configured to actuate a signal responsive to a predetermined condition;
at least a first controller, the first controller in electrical communication with the first event trigger, the first controller in further electrical communication with a first notification interface, and wherein the first controller receives the actuated signal;
at least a first memory, the first memory in electrical communication with the first controller, and wherein the first memory is configured to store at least one destination list, each destination list including at least one destination; and wherein the first controller is configured to issue at least one notification message to at least one destination responsive to receiving an actuated signal, wherein the notification message is issued via the notification interface; and
at least one remote transceiver configured to wirelessly communicate on a predetermined intermittent schedule with the event trigger, the remote transceiver in electrical communication with at least a first sensor, and wherein each of the remote transceivers includes a unique identifier, and wherein each unique identifier is associated with at least one destination list, and wherein the transceiver transmits the unique identifier to the event trigger, and wherein the notification message is issued responsive to the unique identifier.

36. The system of claim 35 wherein the notification interface is in electrical communication with at least one of a packet switched network and a circuit switched network.

37. The system of claim 35 wherein the controller issues the notification message responsive to receipt of a communication from the first remote transceiver.

38. The system of claim 35 wherein the controller issues the notification message responsive to a failure to receive a communication according to the predetermined intermittent schedule.

39. The system of claim 35 wherein the notification message comprises an identification of the predetermined condition.

40. The apparatus of claim 39 wherein the notification message comprises at least one of the group consisting of email, text message, SMS, telephone call, instant message, and tweet.

41. A method of issuing a notification, the method comprising:
recognizing a call at an apparatus including at least a first input configured to recognize an incoming call, at least a first notification interface, at least a first controller, the first controller in electrical communication with the first input, the first controller in further electrical communication with the first notification interface, and a first memory in electrical communication with the first controller, and wherein the memory is configured to store at least one destination;
identifying, at the controller, at least a first characteristic responsive to the recognizing the call;
matching the characteristic to at least a first destination selected from the at least one destination; and
issuing a notification message to the first destination based on the matching.

42. A method of issuing a notification, the method including:
receiving an actuated signal at an apparatus, the apparatus including at least a first input configured to recognize an incoming call, at least a first event trigger configured to actuate a signal responsive to a predetermined condition, at least a first notification interface configured to issue at least one notification message, at least a first controller, the first controller in electrical communication with the first event trigger, the first controller in further electrical communication with the first notification interface, and wherein the first controller receives the actuated signal, and a first memory, the first memory in electrical communication with the first controller, and wherein the memory is configured to store at least one destination;
identifying, at the controller, at least a first characteristic responsive to the receiving the actuated signal;
matching the characteristic to at least a first destination selected from the at least one destination; and
issuing a notification message to the first destination based on the matching.
